(19) United States
(12) Patent Application Publication
(10) Pub. No.: US 2018/0218132 A1
(43) Pub. Date: Aug. 2, 2018

(54) APPLICATION PORTABILITY VIA APPLICATION(S) INSTALLED ON A PORTABLE STORAGE DEVICE

(71) Applicant: Microsoft Technology Licensing, LLC, Redmond, WA (US)

(72) Inventors: Arun C. Kalyanasamy, Redmond, WA (US); John J. Vintzel, Redmond, WA (US); Jason G. Salameh, Bothell, WA (US); Sarjana S. Mitra, Yarrow Point, WA (US)

(21) Appl. No.: 15/423,475

(22) Filed: Feb. 2, 2017

(51) Int. Cl. G06F 21/12; G06F 9/445

(52) U.S. Cl. CPC G06F 21/123; G06F 2221/0753; G06F 8/61

(57) ABSTRACT

Methods, systems, and computer program products are provided that enable software application(s) to be installed onto a portable storage device and executed by a first computing device coupled to the portable storage device without having to install the application(s) onto the first computing device. While the application(s) are being executed, state information associated with the application(s) may be maintained and also stored on the portable storage device. When the portable storage device is de-coupled from the first computing device and coupled to a second computing device, the application(s) installed on the portable storage device may continue execution from the point where the user stopped using the application(s) on the first computing device without having to install the applications(s) on the second computing device.

### BACKGROUND

Computers have become commonplace in our lives, being found in our homes and workplaces as well as a growing variety of public places such as libraries, airports, cafes, and so forth. As people have become more reliant on computers, their desire to use computers wherever they may happen to be has also grown. For example, when users travel away from their home or office, they frequently desire to access programs and/or data that they are accustomed to accessing from their home or office computers. One solution is to re-download the programs to additional computers. However, this consumes valuable network bandwidth and time. Moreover, application-specific data generated on their home or office computer is not available on computers away from their home or office.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods are described herein, including a method that includes installing an application on a portable storage device. State information of the application that is obtained during execution of the application is stored to the portable storage device. The application and the state information are encrypted using at least one first cryptographic key. The portable storage device may be coupled with another computing device to enable the application to be executed on the portable storage device based on the state information, without the application being installed to storage of the computing device.

Systems in computing devices are also described herein, including a system that includes an application installer, a state manager, and an encryption module. The application installer is configured to install an application on a portable storage device. The state manager is configured to store state information of the application obtained during execution of the application to the portable storage device. The encryption module is configured to encrypt the application and the state information using at least one first cryptographic key. The portable storage device may be coupled with another computing device to enable the application to be executed on the portable storage device based on the state information, without the application being installed to storage of the computing device.

In accordance with another method, a determination is made that a portable storage device coupled with a computing device stores an application configured on the portable storage device for execution on the computing device without requiring installation on the computing device. In response to the determination, a user-selectable application identifier for the application is displayed to a user of the computing device. A detection is made of a user that selected the user-selectable application identifier. In response to the detection, a determination is made whether the application is associated with the user. In response to a determination that the application is associated with the user, the application is enabled for execution on the computing device.

In accordance with further system, the further system includes an application detector, a user interface, an application association module, and an application execution enabler. The application detector is configured to determine that a portable storage device coupled with a computing device stores an application configured on the portable storage for execution on the computing device without requiring installation on the computing device. The user interface is configured to, in response to a determination that the portable storage device stores the application, display a user-selectable application identifier for the application to a user of the computing device. The user interface is further configured to detect that a user has selected the user-selectable application identifier. The application association module is configured to in response to a determination that the application is associated with the user, enable the application for execution on the computing device without installation on the computing device.

Further features and advantages of the invention, as well as the structure and operation of various examples of the invention, are described in detail below with reference to the accompanying drawings. It is noted that the invention is not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate examples of the present application and, together with the description, further serve to explain the principles of the examples and to enable a person skilled in the pertinent art to make and use the examples.

FIG. 1A shows a block diagram of a system that enables a user to install an application to a portable storage device, according to an example.

FIG. 1B shows a block diagram of a system that includes a portable storage device coupled to a second computing device, according to an example.

FIG. 2 depicts a flowchart of a method for installing an application on a portable storage device, according to an example.

FIG. 3 shows a block diagram of a computing device coupled to a portable storage device in which an application is installed, according to an example.

FIG. 4 depicts a flowchart of a method for installing application installation file(s) on a portable storage device, according to an example.

FIG. 5 shows a block diagram of a computing device coupled to a portable storage device in which application installation files are installed, according to an example.

FIG. 6 depicts a flowchart of a method for using an application installed on a portable storage device, according to an example.

FIG. 7 is a block diagram of a computing device coupled to a portable storage device from which an application installed thereon is used, according to an example.

FIG. 8 shows an example view of a user interface in which a window displays application identifier(s) for application(s) installed on a portable storage device, according to an example.

FIG. 9A shows an example view of a user interface in which application identifier(s) are integrated with a list of application identifier(s) for application(s) installed on a computing device, according to an example.

FIG. 9B shows an example view of a user interface in which an application identifier is displayed in a manner to indicate that the application identified by the application identifier is enabled for execution, according to an example.

FIG. 10 shows an example view of a user interface in which an application identifier has been moved to a second section, according to an example.

FIG. 11 depicts a flowchart of a method for enabling an application without installation on a computing device, according to an example.

FIG. 12 is a block diagram of a computing device coupled to a portable storage device in which an application installed thereon is enabled, according to an example.

FIG. 13 depicts a flowchart of a method for determining whether an application is associated with a particular user, according to an example.

FIG. 14 is a block diagram of a computing device coupled to a portable storage device in which a determination is made that an application installed on the portable storage device is associated with a particular user, according to an example.

FIG. 15 depicts a flowchart of a method for enabling an application, according to another example.

FIG. 16 is a block diagram of a computing device coupled to a portable storage device in which an application installed thereon is enabled, according to another example.

FIG. 17 depicts a flowchart of a method for enabling an application, according to a further example.

FIG. 18 is a block diagram of a computing device coupled to a portable storage device in which an application installed thereon is enabled, according to a further example.

FIG. 19 is a block diagram of an example mobile device that may be used to implement various examples.

FIG. 20 is a block diagram of an example processor-based computer system that may be used to implement various examples.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more examples that incorporate the features of the present invention. The scope of the present invention is not limited to the disclosed examples. The disclosed examples merely exemplify the present invention, and modified versions of the disclosed examples are also encompassed by the present invention. Examples of the present invention are defined by the claims appended hereto.

References in the specification to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to effect such feature, structure, or characteristic in connection with other examples whether or not explicitly described.

Numerous exemplary examples are described as follows. It is noted that any section/subsection headings provided herein are not intended to be limiting. Examples are described throughout this document, and any type of example may be included under any section/subsection. Furthermore, examples disclosed in any section/subsection may be combined with any other examples described in the same section/subsection and/or a different section/subsection in any manner.

### II. Exemplary Examples

Examples described herein enable one or more software application(s) (also referred to as “applications” or “apps”) to be installed onto a portable storage device and executed by a first computing device coupled to the portable storage device without having to install the application(s) onto the first computing device. While the application(s) are being executed, state information associated with the application(s) may be maintained and also stored on the portable storage device. When the portable storage device is de-coupled from the first computing device and coupled to a second computing device, the application(s) installed on the portable storage device may continue execution from the point where the user stopped using the application(s) on the first computing device without having to install the applications(s) on the second computing device.

The foregoing may be achieved regardless of the type of computing device used to execute the application(s) installed on the portable storage device. For example, the first computing device may be a desktop computer, and the second computing device may be a smart phone or tablet. To account for potential compatibly issues between the first computing device and the second computing device, additional components may be downloaded and/or installed that enable the application(s) to properly execute on the second computing device. The additional components may provide additional resources and/or functionality for the application(s), such as additional language functionality, graphics functionality, hardware architecture functionality, etc.

For example, suppose a user is playing a video game on a mobile device, such as a tablet or smart phone. However, the user gets frustrated with the smaller screen size and decides she wants to play the video game on her desktop computer. The user would simply remove the portable storage device from the mobile device and couple it to the desktop computer. Additional components may be downloaded to support the enhanced graphics functionality and/or hardware architecture supported by the desktop computer. Once the additional components are installed, the user may resume playing the video game from the point at which she stopped playing the game on the mobile device.

In accordance with an example, the application(s) installed on the portable storage device are Universal Windows Platform (UWP) applications, which are platform-homogenous applications (i.e., applications that can be executed on any device (e.g., a computer, tablet, smartphone, etc.)) executing the same operating system. In accordance with such an example, the additional component(s) may be “resource packages” that are downloaded from an application store (e.g., the Windows Store™ provided by Microsoft Corporation, the App Store™ provided by Apple, Inc., the Google Play Store™ provided by Google, Inc., etc.). In other examples, the application(s) installed on the portable storage device may be other types of applications.

In situations in which the second computing device requires the application(s) to be installed thereon to be executed, the portable storage device may further store one or more application installation files that are used to install the application(s) onto the second computing device.

Accordingly, the examples described herein advantageously allow a user to continue using an application from any computing device, and across computing devices, in a simple and efficient manner without having to download and/or install the application on each computing device. Moreover, by simply requiring certain components to be downloaded (rather than the entire application) and/or storing application installation file(s) on the portable computing device, network bandwidth, which is normally consumed from downloading such components and installation file(s), is conserved. It is noted that while the application does not need to be installed (e.g., files associated with the application do not need to be copied and/or located on the computing device, but can be accessed on the portable storage device), one or more additional steps may be performed by in order for the computing device to execute the application. For example, the computing device may perform a registration process that registers the application on the computing device, which may enable the computing device to access and/or execute the application.

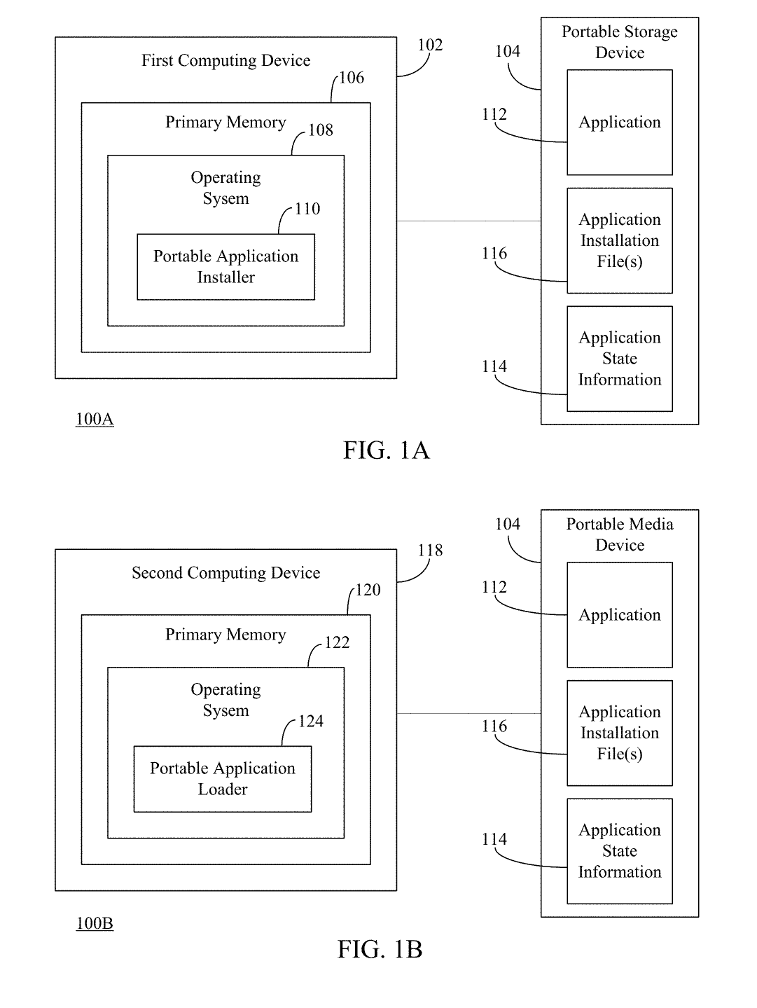

For instance, FIG. 1A shows a block diagram of a system 100A that enables a user to install an application to a portable storage device 104 according to an example. As shown in FIG. 1A, system 100A includes a first computing device 102 and a portable storage device 104, which is coupled to first computing device 102. Examples of computing device 102 include, but are not limited to, any type of stationary or mobile computing device, including a Microsoft® Surface® device, a personal digital assistant (PDA), a laptop computer, a notebook computer, a tablet computer such as an Apple iPad™, a netbook, a mobile phone (e.g., a smart phone such as an Apple iPhone®), a wearable computing device, or other type of mobile device, or a stationary computing device such as a desktop computer or PC (personal computer). Examples of portable storage device 104 include, but are not limited to, an external hard drive, a memory card (e.g., a secure digital (SD) card, a compact flash memory card, etc.), a universal serial bus (USB)-based memory stick or thumb drive, and/or the like.

Computing device 102 includes a primary (or “main”) memory 106. Primary memory 106 includes one or more physical hardware memory devices accessible by one or more processors (not shown in FIG. 1) of first computing device 102. Examples of primary memory 106 include a random access memory (RAM) (e.g., dynamic RAM (DRAM), synchronous DRAM (SDRAM), dual-data rate RAM (DDRRAM), etc.).

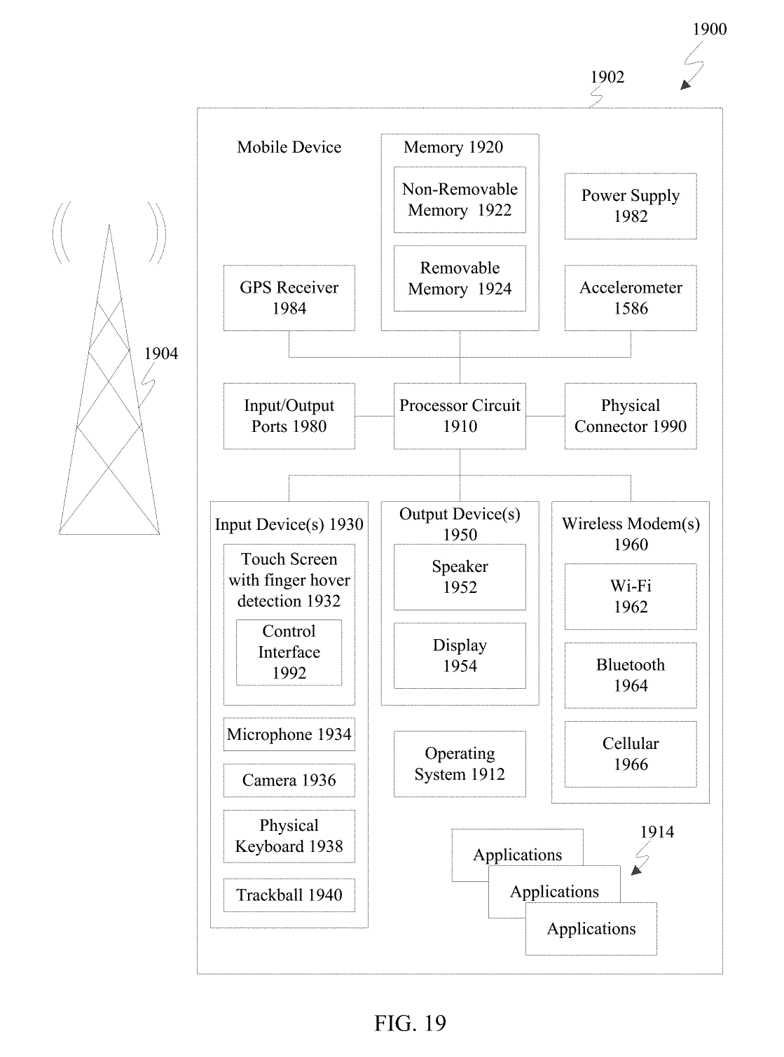

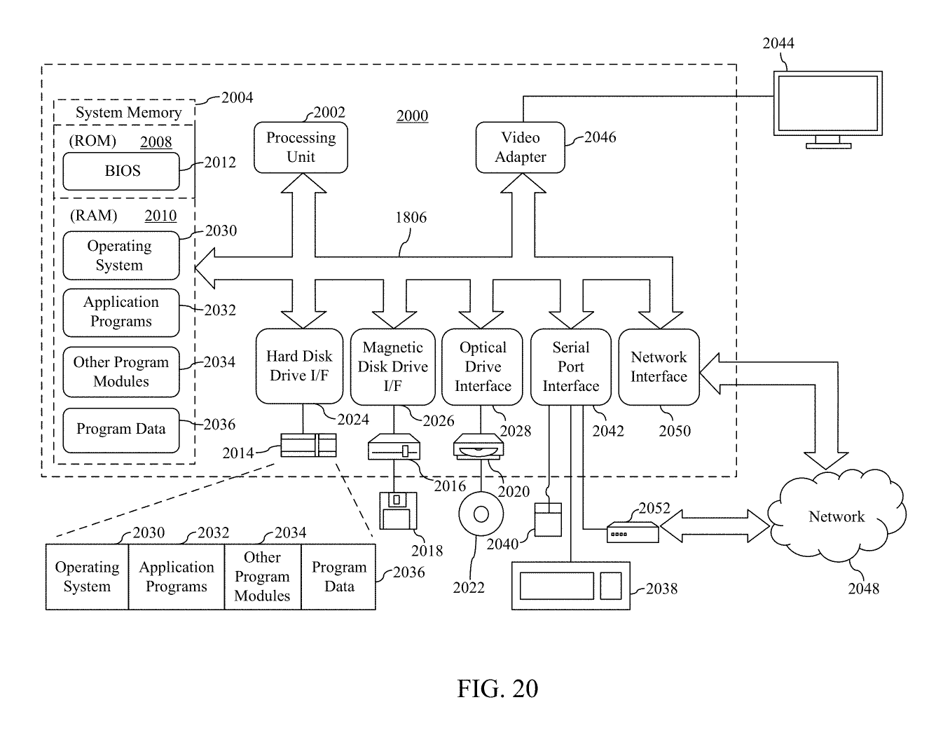

As shown in FIG. 1A, primary memory 106 stores an operating system 108. Operating system 108 may manage one or more hardware components (e.g., primary memory 106, processor(s), etc.) and one or more software applications executing on computing device 102. Examples of operating system 110 include, but are not limited to, Microsoft Windows 10®, Google Android®, Apple iOS®, Linux®, etc. Example hardware component(s) of first computing device 102 are described in detail below with reference to FIGS. 19 and 20.

Operating system 108 may have one or more components that perform tasks relating to the installation of software in memory or devices coupled to first computing device 102. One such component is portable application installer 110. Portable application installer 110 is configured to install an application 112 on to portable storage device 104. Application 112 may be executed by a processor (not shown in FIG. 1) of first computing device 102 without having to be installed on first computing device. While application 112 is being executed, application state information 114 associated with application 112 may be maintained and stored on portable storage device 104. Application state information 114 may indicate a state of operation of application 112. Application state information 114 may include, but is not limited to, application settings, video game scores, program variables, content generated via application 112 and/or any other information that indicates the state of operation of application 112. In accordance with examples, application 112 is a UWP application or other type of application. It is noted while FIG. 1A shows that only a single application (i.e., application 112) is installed on portable storage device 104, any number of applications may be installed on portable storage device 104.

In accordance with an example, portable application installer 110 is also configured to encrypt application 112 and/or application state information 114. Portable application installer 110 may be configured to perform the encryption using one or more cryptographic keys that are specific to the user. For example, the cryptographic key(s) may be associated with a user identification (ID) associated with the user, which the user uses to log into first computing device 102 and/or other computing devices. In accordance with an example, one cryptographic key is used to encrypt both application 112 and application state information 114. In accordance with another example, one cryptographic key is used encrypt application 112 and another cryptographic key is used to encrypt application state information 114. An example of a user ID includes, but is not limited to, a Microsoft Account ID (also referred to as an MSA ID), which enables users to log into websites (e.g., Outlook.com®), devices (computers, tablets, smart phones, etc.), and/or applications (e.g., Visual Studio®) using a single ID. Portable application installer 110 may include an encryption module (as described in further detail below) configured to encrypt application 112 and/or application state information 114 according to any encryption technique or algorithm known to persons skilled in the relevant art(s), including a private-key encryption technique or a public-key encryption technique (e.g., PGP (pretty good privacy), etc.), content scrambling system (CSS), advanced encryption standard (AES), or other encryption algorithm. Although several examples of encryption techniques are mentioned, these examples are provided for purposes of illustration and are not intended to be limiting.

By storing application 112 and application state information 114 on portable storage device 104, a user is enabled to couple portable storage device 112 to any computing device, launch application 112 and continue using application 112 from the point (a program state) where the user stopped using application on first computing device 102.

Portable application installer 110 may further be configured to store one or more application installation files 116 that are used to install application 112 onto portable storage device 104. Examples of application installation file(s) 116 include, but are not limited, an installer package (e.g., an .msi file) containing instructions regarding installing application 112, a setup file (e.g., a setup.exe. file) that causes the launching of the installation procedure, one or more library files (e.g., dynamic link library (DLL) files), configuration/description files (e.g., .ini files), and/or any other file(s) required to install application 112.

By storing application installation file(s) 116 on portable storage device 104, a user is enabled to couple portable storage device 104 to a computing device not associated with the user (e.g., another user's device or a device in which the user does not sign into using a user ID), and install application 112 onto the other computing device without having to download application installation file(s) 116 from a remote data store, such as an application store.

In accordance with an example, application 112 is only installed if the user has a license to install and/or execute application 112 on the other computing device. In accordance with such an example, portable application installer 110 is configured to encrypt application installation file(s) 116. Portable application installer 110 may be configured to perform the encryption using a cryptographic key that is associated with a valid license for application 112. For example, after obtaining the license to install and/or execute application 112 on another computing device, the other computing device may be provided the cryptographic key used to decrypt application installation file(s) 116, thereby enabling installation of application 112 on the other computing device.

FIG. 1B shows a block diagram of a system 100B that includes portable storage device 104 coupled to a second computing device 118 that is different than first computing device 102 in accordance with an example. Second computing device 118 includes a primary memory 120, which stores an operating system 124. Primary memory 120 and operating system 124 are examples of primary memory 106 and operating system 108, as described with reference to FIG. 1A. Examples of second computing device 118 include, but are not limited to, a desktop computer, a smart phone, a personal data assistant (PDA), a tablet, a laptop, other type of computing device mentioned elsewhere herein, etc.

Operating system 122 may have one or more components that perform tasks relating to the loading and/or execution of software on second computing device 118. One such component is portable application loader 124. Upon coupling (e.g., inserting, attaching, etc.) portable storage device 104 to second computing device 118 (after disconnecting from first computing device 102 of FIG. 1A), portable application loader 124 may be configured to detect portable storage device 104 and/or determine whether one or more applications (e.g., application 112) are installed thereon. Portable application loader 124 may also be configured to determine whether second computing device 118 is associated with the user of first computing device 102 or a different user. Portable application loader 124 may further be configured to determine whether additional components of application 112 must be retrieved and/or installed in order for application 112 to properly execute on second computing device 118. The additional component(s) may comprise one or more resource packages, for example, a language resource package, a graphics resource package, a user interface resource package, an architecture-specific resource package, etc. The language resource package may provide support for one or more additional languages for application 112. The graphics resource package may comprise resource and/or shader application assets that may depend on a level or generation of one or more graphics processing units (GPUs) of second computing device 118. The user interface resource package may comprise dialog boxes and/or other user interface element assets that may be configured based on the display resolution of a display device coupled to and/or integrated with second computing device 118. The architecture-specific resource package may comprise application binaries and/or executables that depend on the architecture (e.g., x86, ARM® architecture, 32-bit, 64-bit, etc.) of processors (not shown) of second computing device 118.

Upon determining the application(s) installed on portable storage device 104, portable application loader 124 may cause one or more user-selectable application identifiers for each of the application(s) installed on portable storage device 104 to be displayed to a user (e.g., via a graphical user interface (GUI) rendered to a display device coupled to or integrated with second computing device 118). The GUI may further display indicator(s) to the user indicating whether additional component(s) must be retrieved and/or installed and/or whether installation of application 112 on second computing device 118 is required on second computing device 118, for example, due to second computing device 118 being associated with a different user.

When determining that second computing device 118 is associated with the user and/or responsive to the user activating the user-selectable application identifier that identifies application 112 (e.g. by touching it on a touchscreen, pointing to it with a mouse and clicking, etc.), portable application loader 124 may retrieve application state information 114 and execute application 112 based on application state information 114, thereby enabling the user to continue using application 112 from the point where the user stopping using application 112 on first computing device 102. In accordance with an example in which application 112 and/or application state information 114 are encrypted, portable application loader 124 may obtain user-specific cryptographic key(s) and decrypt application 112 and/or application state information 114 based on the user-specific cryptographic key(s). The user-specific cryptographic key(s) may be stored and retrieved from portable storage device 104. Alternatively, the user-specific cryptographic key(s) may be stored and retrieved from a remote data source (e.g., an application store, a software license server, etc.). Portable application loader 124 may include a decryption module configured to decrypt application 112 and/or application state information 114 encrypted according to any encryption scheme mentioned elsewhere herein or otherwise known.

When determining that additional components are required, portable application loader 124 may retrieve the additional components from a remote data source (e.g., an application store) that is remotely located from second computing device 118, install the additional components, and execute application 112 in accordance with the additional components.

In response to determining that second computing device 118 is not associated with the user, portable application loader 124 may retrieve application installation file(s) 116 from portable storage device 104 and install application 112 onto second computing device 118 using application installation file(s) 116. In the event that a license is required to install and/or execute application 112, portable application loader 124 may request the user to accept the install, may prompt the user to purchase a license, and may begin installation of application 112 after a license is purchased. In accordance with an example in which application installation file(s) 116 are encrypted, portable application loader 124 may obtain a license-specific cryptographic key after the user has purchased the license and decrypt application installation file(s) 116 based on the license-based cryptographic key. The license-based cryptographic key may be stored and retrieved from portable storage device 104. Alternatively, the license-specific cryptographic key may be stored and retrieved from a remote data source (e.g., an application store, a software license server, etc.).

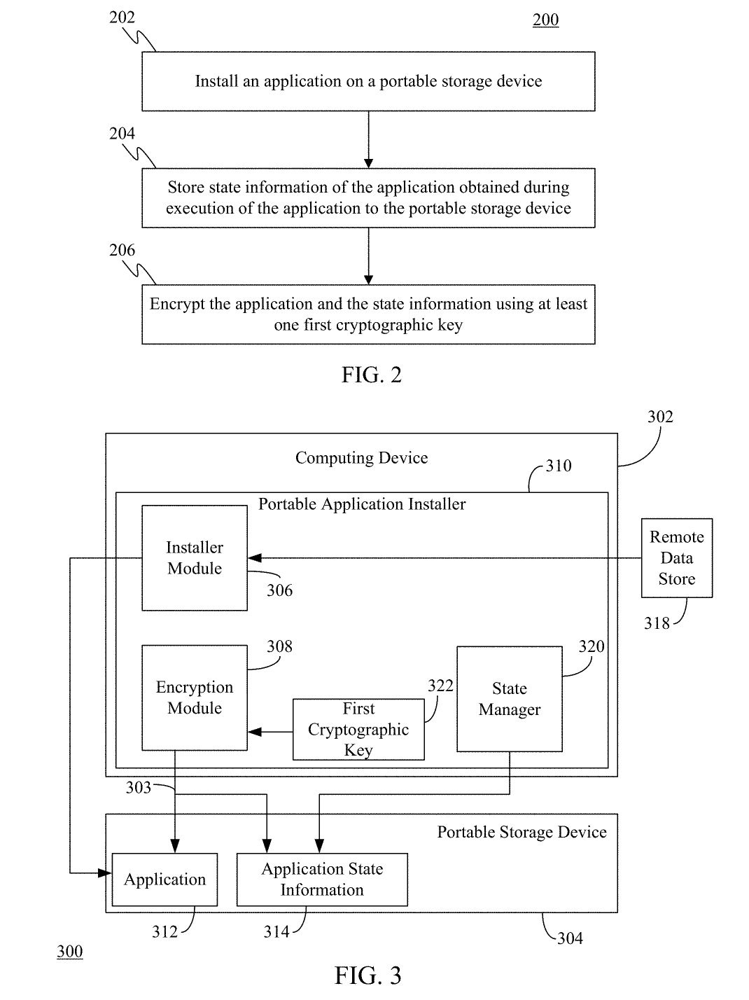

Accordingly, in examples, an application may be installed on a portable storage device in many ways. For instance, FIG. 2 depicts a flowchart 200 of a method for installing an application on a portable storage device in accordance with an example. In an example, flowchart 200 may be implemented by a computing device 302 shown in FIG. 3. FIG. 3 is a block diagram 300 of computing device 302 coupled to a portable storage device 304 in accordance with an example. Computing device 302 is an example of first computing device 102, and portable storage device 304 is an example of portable storage device 104, as described above with reference to FIG. 1A. As shown in FIG. 3, computing device 302 includes a portable application installer 310. Portable application installer 310 is an example of portable application installer 110, as shown in FIG. 1. As further shown in FIG. 3, portable application installer 310 includes an installer module 306, an encryption module 308, and a state manager 320. Other structural and operational examples will be apparent to persons skilled in the relevant art(s) based on the following discussion regarding flowchart 200 and block diagram 300.

Flowchart 200 begins with step 202. In step 202, an application is installed on a portable storage device. For example, with reference to FIG. 3, installer module 306 may retrieve (e.g., download) application installation file(s) from a remote data store 318 (e.g., an application store) and execute the application installation file(s), which cause the application to be installed to a location designated by the user. In the example shown in FIG. 3, the user has designated portable storage device 304 as the location for the installation of the application (e.g., application 312). Application 312 is an example of application 112, as described above with reference to FIG. 1.

At step 204, state information of the application obtained during execution of the application is stored to the portable storage device. For example, with reference to FIG. 3, state manager 320 may store application state information 314 of application 312 on portable storage device 304. Application state information 314 may be obtained during execution of application 312 (e.g., by a processor (not shown) of computing device 302). Application state information 314 may indicate a state of operation of application 312. Application state information 314 may include, but is not limited to, application settings, video game scores, variable values, content generated via application 312 and/or any other information that indicates the state of operation of application 312.

At step 206, the application and the state information are encrypted using at least one first cryptographic key. For example, with reference to FIG. 3, encryption module 308 may encrypt or may send a command 305 that causes application 312 and application state information 314 to be encrypted using a first cryptographic key 322.

In accordance with one or more examples, first cryptographic key 322 is a user-specific cryptographic key. For example, first cryptographic key 322 may be associated with a user ID associated with the user, which the user uses to log into first computing device 302 and/or other devices, websites, and/or applications. Examples of such a user ID is a Microsoft Account ID (also referred to as an MSA ID), which enables users to log into websites (e.g., Outlook.com®), devices (computers, tablets, smart phones, etc.), and/or applications (e.g., Visual Studio®) using a single ID. By doing so, application 312 and application state information 314 may be decrypted and utilized on other computing devices (e.g., computing device 118, as shown in FIG. 1B) on which the user is enabled to log into using the same user ID.

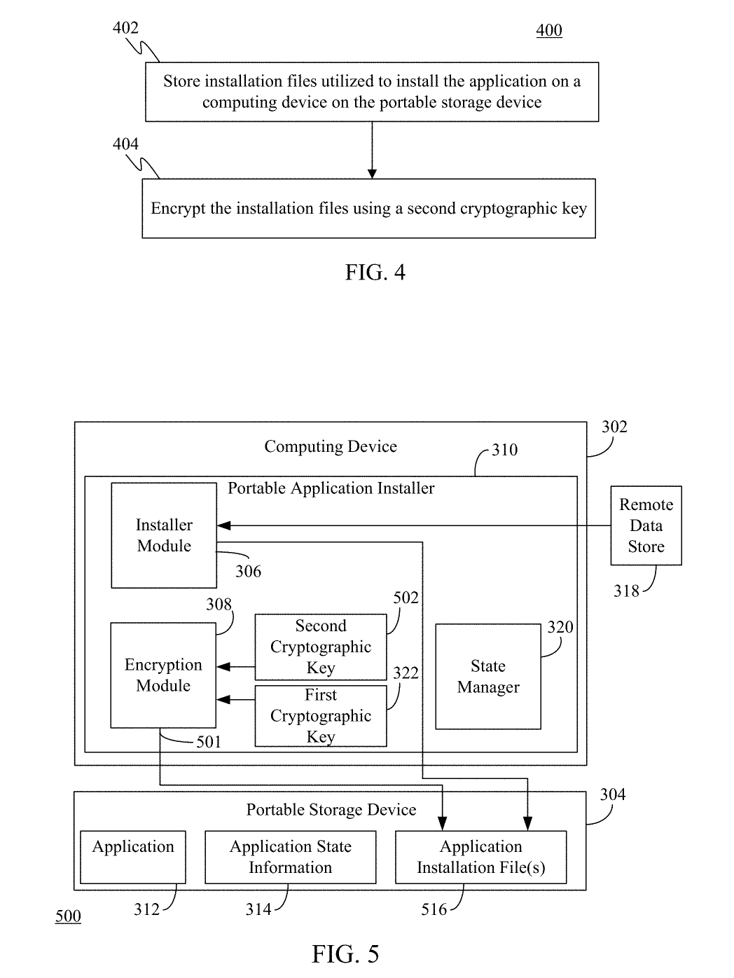

In accordance with one or more examples, portable application installer 310 may further be configured to store application installation file(s) onto portable storage device 104. The application installation file(s) may be used to install application 312 onto another computing device. For instance, FIG. 4 depicts a flowchart 400 of a method for installing application installation file(s) on a portable storage device in accordance with an example. The method of flowchart 400 may be implemented by computing device 302 shown in FIG. 5. FIG. 5 is a block diagram 500 of computing device 302 (as described above with reference to FIG. 3) coupled to portable storage device 304 (as also described above with reference to FIG. 3) in accordance with an example. Other structural and operational examples will be apparent to persons skilled in the relevant art(s) based on the following discussion regarding flowchart 400 and block diagram 500.

Flowchart 400 begins with step 402. In step 402, installation files utilized to install the application on a computing device are stored on the portable storage device. For example, with reference to FIG. 5, installer module 306 may store application installation file(s) (e.g., retrieved from remote data store 318) to a location designated by the user. In the example shown in FIG. 4, the user has designated portable storage device 304 as the location for storing the application installation file(s) (e.g., application installation file(s) 516). Application installation file(s) 516 are an example of application installation file(s) 116, as described above with reference to FIGS. 1A and 1B.

At step 404, the installation files are encrypted using a second cryptographic key. For example, with reference to FIG. 5, encryption module 308 may encrypt or may send a command 501 that causes application installation file(s) 516 to be encrypted using a second cryptographic key 502.

In accordance with one or more examples, second cryptographic key 502 is a license-specific cryptographic key. For example, second cryptographic key 502 may be associated with a valid license for application 312. By doing so, application installation file(s) 516 may be decrypted and utilized on other computing devices so long as a valid license for application 312 is obtained.

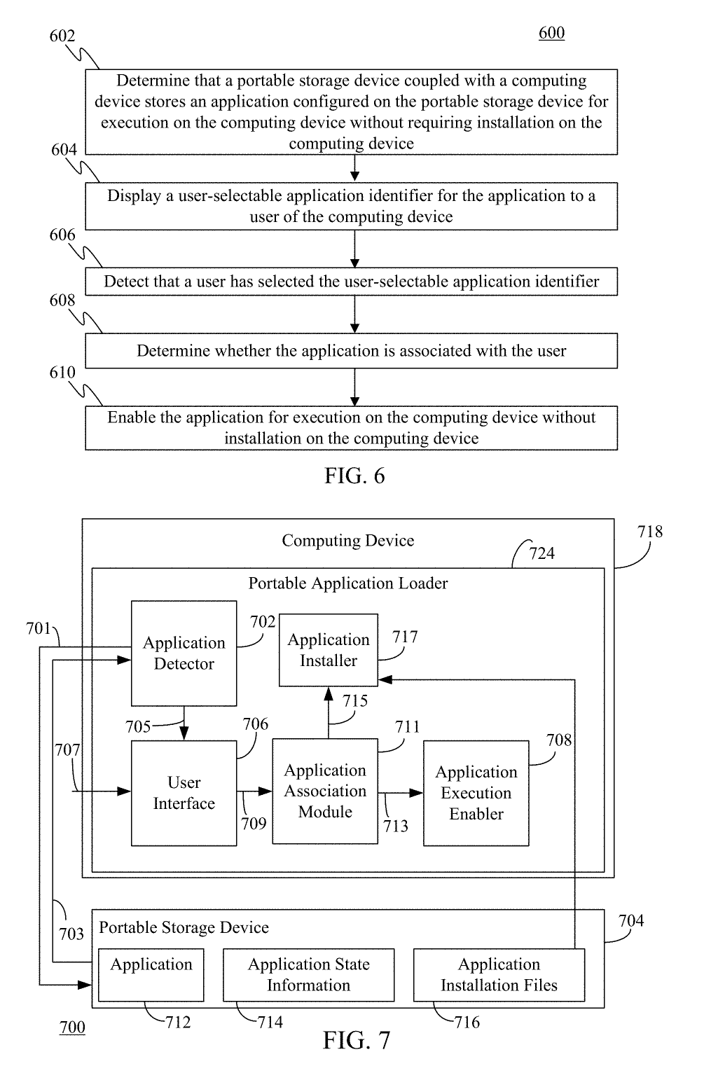

As described above, applications installed on a portable storage device may be used on different computing devices without requiring installation on those devices. For instance, FIG. 6 depicts a flowchart 600 of a method for using an application installed on a portable storage device in accordance with an example. The method of flowchart 600 may be implemented by a computing device 718 in FIG. 7. FIG. 7 is a block diagram 700 of computing device 718 coupled to a portable storage device 704 in accordance with an example. Computing device 718 is an example of second computing device 118, as shown in FIG. 1B, and portable storage device 704 is an example of portable storage device 304, as shown in FIG. 5. As shown in FIG. 7, computing device 718 includes a portable application loader 724. Portable application loader 724 is an example of portable application loader 124, as shown in FIG. 1B. As further shown in FIG. 7, portable application loader 724 includes an application detector 702, a user interface 706, an application execution enabler 708, an application association module 711, and an application installer 717. Portable storage device 704 has stored thereon an application 712, application state information 714, and application installation file(s) 716. Application 712, application state information 714, and application installation file(s) 716 are examples of application 312, application state information 314, and application installation file(s) 516, as respectively described above with reference to FIGS. 3 and 5. Other structural and operational examples will be apparent to persons skilled in the relevant art(s) based on the following discussion regarding flowchart 600 and block diagram 700.

Flowchart 600 begins with step 602. In step 602, a determination is made that a portable storage device coupled with a computing device stores an application configured on the portable storage device for execution on the computing device without requiring installation on the computing device. For example, with reference to FIG. 7, after portable storage device 704 is coupled to computing device 718, application detector 702 may send a read command 701 to portable storage device 704. Responsive to read command 701, portable storage device 704 may provide read data 703 that includes an application identifier for each application (e.g., application 712) installed on portable storage device 704. Application detector 702 may determine that portable storage device 704 stores application(s) that are configured on portable storage device 704 for execution on computing device 718 without requiring installation on computing device 718 based on the identifiers included in read data 703. The determined application identifier(s) (e.g., application identifier 705) are provided to user interface 706.

At step 604, in response to the determination of step 702, a user-selectable application identifier for the application is displayed to a user of the computing device. For example, with reference to FIG. 7, user interface 706 displays application identifier 705 received from application detector 702.

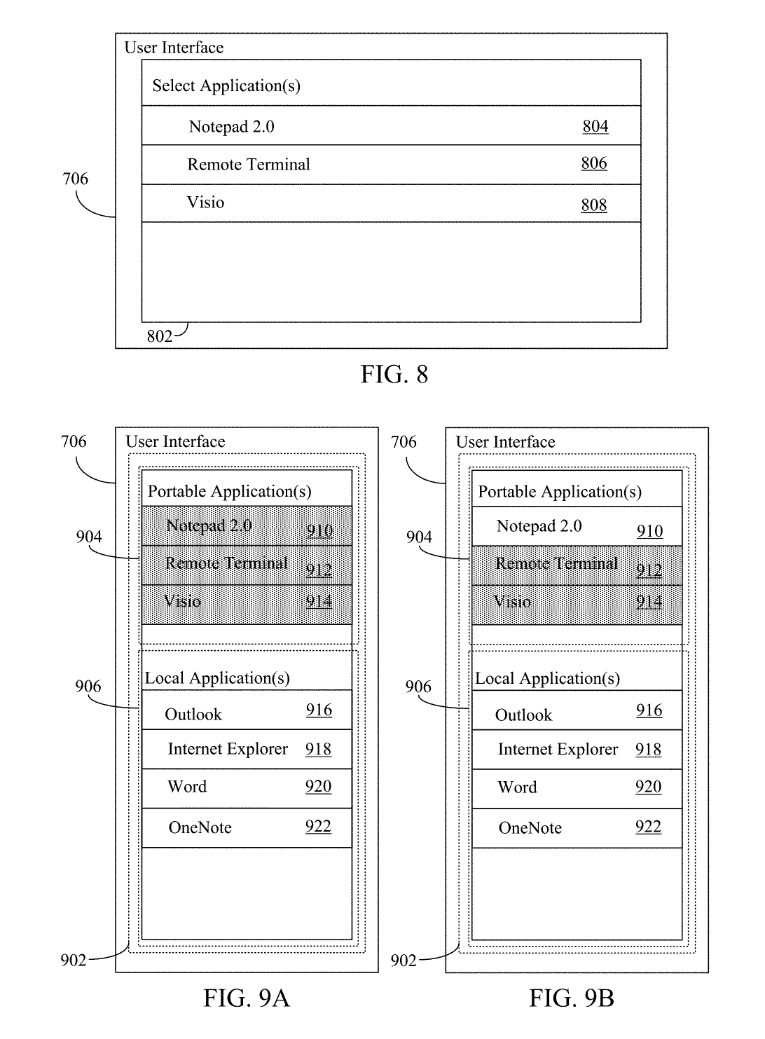

In accordance with an example, application identifier 705 is shown via a window that is displayed to the user responsive to receiving read data 703. By way of example, FIG. 8 shows an example view of user interface 706 in which a window 802 displays one or more application identifiers 804, 806, and 808 for application(s) (e.g., application 712) installed on a portable storage device (e.g., portable storage device 704) in accordance with an example. In the example shown in FIG. 8, three applications are installed on portable storage device 704, where first application identifier 804 identifies the first application (“Notepad 2.0”), a second application identifier 806 identifies the second application (“Remote Terminal”), and a third application identifier 808 identifies the third application (“Visio”).

In accordance with another example, application identifier 705 is integrated with a listing of application identifier(s) for application(s) installed on computing device 718. By way of example, FIG. 9A shows an example view of user interface 706 in which application identifier(s) are integrated into a list 902 of application identifier(s) for application(s) installed on computing device 718 and application identifier(s) for application(s) installed on portable storage device 704. List 902 of FIG. 9A may be displayed in response to detecting input from the user that causes list 902 to be displayed (e.g., activating the “Start” button of a Microsoft Windows® OS).

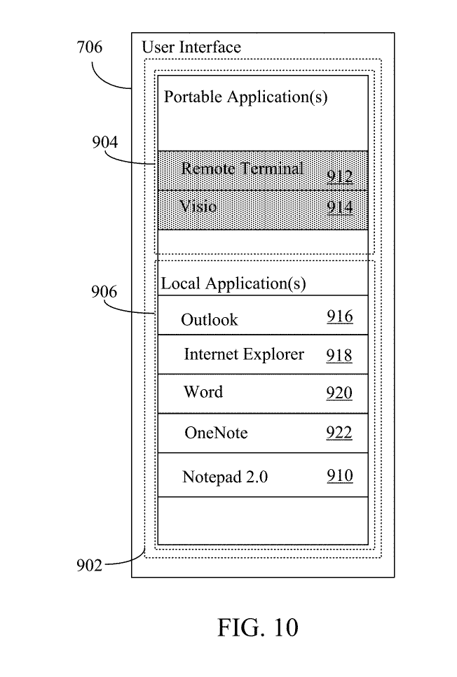

As shown in FIG. 9A, list 902 includes a first section 904 and a second section 906. First section 904 displays application identifiers 910, 912, and 914 for applications that are installed on portable storage device 704, and second section 906 displays application identifiers 916, 918, 920, and 922 for applications that are installed on computing device 718. Each of application identifiers 910, 912, and 914 are user-selectable, which, when activated (e.g. by touching it on a touchscreen, pointing to it with a mouse and clicking, etc.), launch the application identified by the selected application identifier. As shown in FIG. 9A, each of application identifiers 910, 912, and 914 may initially be displayed in a different manner than application identifiers 916, 918, 920, and 922. For example, application identifiers 910, 912, and 814 may be greyed out or shown with a different color scheme (e.g., grayscale) until the corresponding applications are enabled for execution. Additional details regarding how applications are enabled for execution are described below with reference to step 608 and FIGS. 10, 11, and 15-18.

Referring again to FIG. 6, at step 606, it is detected that a user has selected the user-selectable application identifier. For example, with reference to FIG. 7, user interface 706 may detect user input 707 indicative of a user selecting (e.g. by touching it on a touchscreen, pointing to it with a mouse and clicking, etc.) the user-selectable application identifier. User input 707 may comprise a selection of one of application identifiers 804, 806, or 808 (as shown in FIG. 8), or one of application identifier(s) 910, 912, or 914 (as shown in FIG. 9A).

At step 608, in response to the detection at step 606, a determination is made as to whether the application is associated with the user. For example, with reference to FIG. 7, application association module 711 may receive an indicator 709 from user interface 706 that indicates that the user has selected a particular application identifier. Application association module 711 may determine whether the application is associated with the user. In response to determining that the application is associated with the user, flow continues to step 610.

At step 610, the application is enabled for execution on the computing device without installation on the computing device. For example, with reference to FIG. 7, application execution enabler 708 may receive an indicator 713 from application association module 711 that indicates that the user is associated with the application and enable application 712 for execution on computing device 718 without installation on computing device 718. Application execution enabler 708 may enable the application (e.g., application 712) identified by the particular application identifier selected by the user in step 606.

After a selected application has been enabled for execution on computing device 718, the application identifier corresponding to the selected application may be displayed in a manner to indicate that the selected application is enabled for execution. By way of example, FIG. 9B shows an example view of user interface 706 in which an application identifier is displayed in a manner to indicate that the application identified by the application identifier is enabled for execution in accordance with an example. In the example shown in FIG. 9B, the Notepad 2.0 application is enabled for execution, and therefore, its corresponding application identifier (i.e., application identifier 910) is no longer greyed out.

It is noted that the manner in which application identifier(s) are displayed are not limited to the techniques described above with reference to FIGS. 8, 9A, and 9B and that application identifier(s) may be displayed and presented to the user in any manner.

In accordance with one or more examples, in response to determining that the application is not associated with the user, the user is enabled to install the application on the computing device. For example, with reference to FIG. 7, application association module 711 may provide an indicator 715 to application installer 717 that indicates that application 712 is not associated with the user. In response, application installer 717 may cause user interface 706 to display an option to the user that enables the user to install application 712 onto computing device 718. In response to the user selecting the option, application installer 717 may retrieve application installation file(s) 716 from portable storage device 704 and install application 712 onto computing device 718 using application installation file(s) 716, thereby enabling application 712 to be executed.

In an example in which an integrated list is used to display application identifier(s) (as described above with reference to FIGS. 9A and 9B), an application identifier corresponding to the application installed on computing device 718 may be moved to the second section to indicate that the application installed on portable storage device 704 is now installed on computing device 718. For example, FIG. 10 shows an example view of user interface 706 in which application identifier 910 has been moved to second section 906 responsive to the application identified by application identifier 910 (i.e., Notepad 2.0) being installed on computing device 718 in accordance with an example. In the example shown in FIG. 10, application identifier 910 (which was previously displayed in first section 904, as shown in FIGS. 9A and 9B) is now displayed in second section 906 after Notepad 2.0 is installed on computing device 718 and is no longer displayed in first section 904.

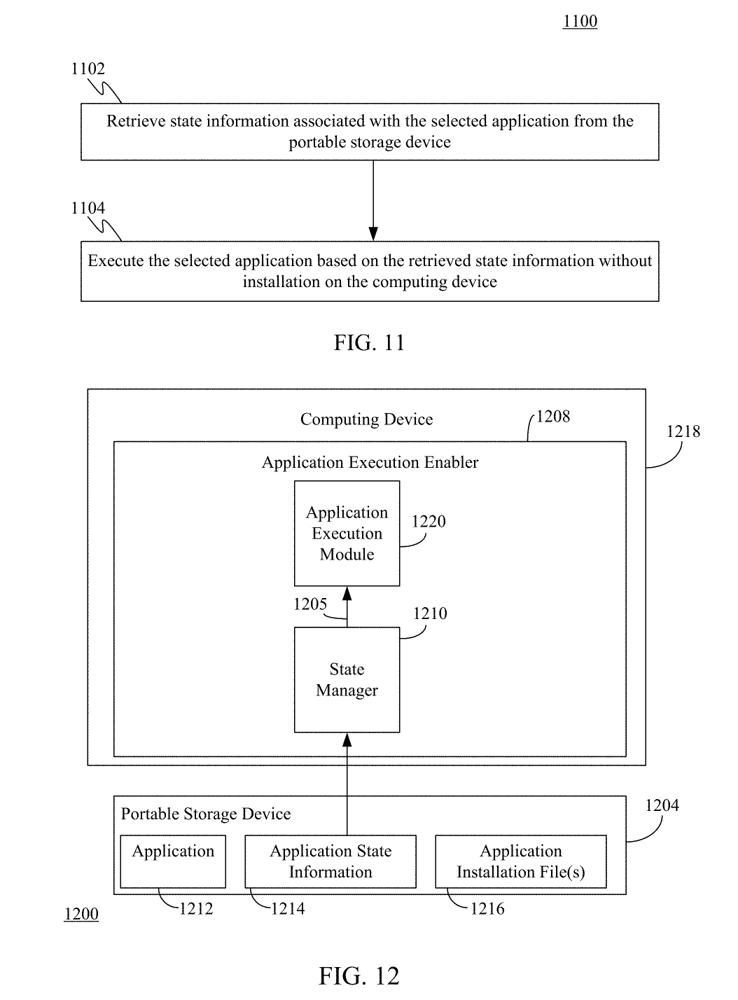

In examples, an application may be enabled for execution without installation on a computing device in many ways. For instance, FIG. 11 depicts a flowchart 1100 of a method for enabling an application without installation on a computing device in accordance with an example. In an example, flowchart 1100 may be implemented by a computing device 1218 in FIG. 12. FIG. 12 is a block diagram 1200 of computing device 1218 coupled to a portable storage device 1204 in accordance with an example. Computing device 1218 is an example of second computing device 718, and portable storage device 1204 is an example of portable storage device 704, as described above with reference to FIG. 7. As shown in FIG. 12, computing device 1218 includes an application execution enabler 1208. Application execution enabler 1208 is an example of application execution enabler 708, as shown in FIG. 7. As further shown in FIG. 12, application execution enabler 1208 includes a state manager 1210, and an application execution module 1220. Portable storage device 1204 has stored thereon an application 1212, application state information 1214, and application installation file(s) 1216. Application 1212, application state information 1214, and application installation file(s) 1216 are examples of application 712, application state information 714, and application installation file(s) 716, as described above with reference to FIG. 7. Other structural and operational examples will be apparent to persons skilled in the relevant art(s) based on the following discussion regarding flowchart 1100 and block diagram 1200.

Flowchart 1100 begins with step 1102. In step 1102, state information associated with the selected application is retrieved from the portable storage device. For example, with reference to FIG. 12, state manager 1210 that indicates that application 1212 is associated with the user. In response, state manager 1210 may retrieve application state information 1214 from portable storage device 1204.

At step 1104, the selected application is executed based on the retrieved state information without installation on the computing device. For example, with reference to FIG. 12, state manager 1210 provides retrieved state information 1205 to application execution module 1220, and application execution module 1220 may execute application 1212 based on retrieved state information 1205. By doing so, the user is able to continue execution of application 1212 from the point where the user stopped using the application 1212 on another computing device (e.g., computing device 302, as described above with reference to FIG. 3).

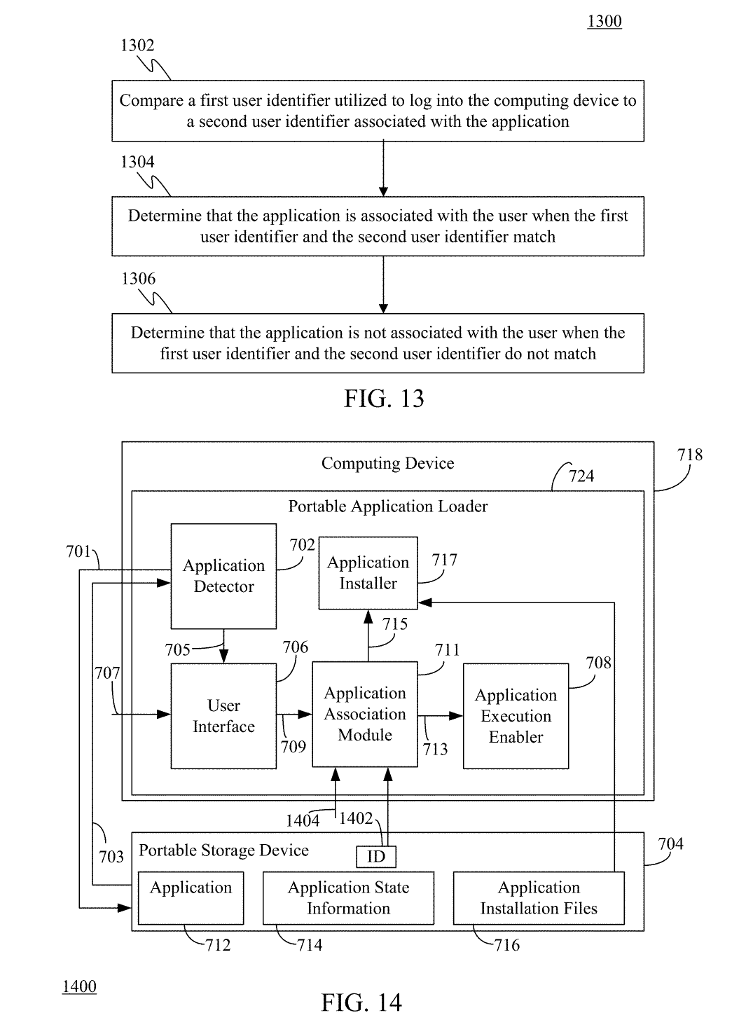

In examples, application association module 711 (as described above with reference to FIG. 7) may determine whether an application (e.g., application 712 or application 1212) is associated with a user in many ways. For instance, FIG. 13 depicts a flowchart 1300 of a method for determining whether an application is associated with a user in accordance with an example. The method of flowchart 1300 may be implemented by computing device 718 in FIG. 14. FIG. 14 is a block diagram of a system 1400 that includes computing device 718 coupled to a portable storage device 704 (as described above with reference to FIG. 7) in accordance with an example. Other structural and operational examples will be apparent to persons skilled in the relevant art(s) based on the following discussion regarding flowchart 1300 and system 1400.

Flowchart 1300 begins with step 1302. At step 1302, a first user identifier utilized to log into the computing device is compared with a second user identifier associated with the application. For example, with reference to FIG. 14, portable storage device 704 may store a user ID 1402 that is associated with application 712. For example, ID 1402 may be an ID the user used to log into another computing device on which application 712 was executed. Application association module 711 may retrieve ID 1402 and compare it to a user ID 1404 that the user uses to log into computing device 718.

At step 1304, a determination is made that the application is associated with the user when the first user identifier and the second user identifier match. For example, with reference to FIG. 14, application association module 711 may determine that application 712 is associated with the user when ID 1402 and ID 1404 match. In response, application execution enabler 708 may enable application 712 for execution (e.g., by application execution module 1220, as described above with reference to FIG. 12) without installation on computing device 718. For example, upon a user activating a user-selectable application identifier identifying application 712, application execution module 1220 may execute application 712.

At step 1306, a determination is made that the application is not associated with the user when the first user identifier and the second user identifier do not match. For example, with reference to FIG. 14, application association module 711 may determine that application 712 is not associated with the user when ID 1402 and ID 1404 do not match. In response, application execution enabler 708 may require installation of application 712 onto computing device 718.

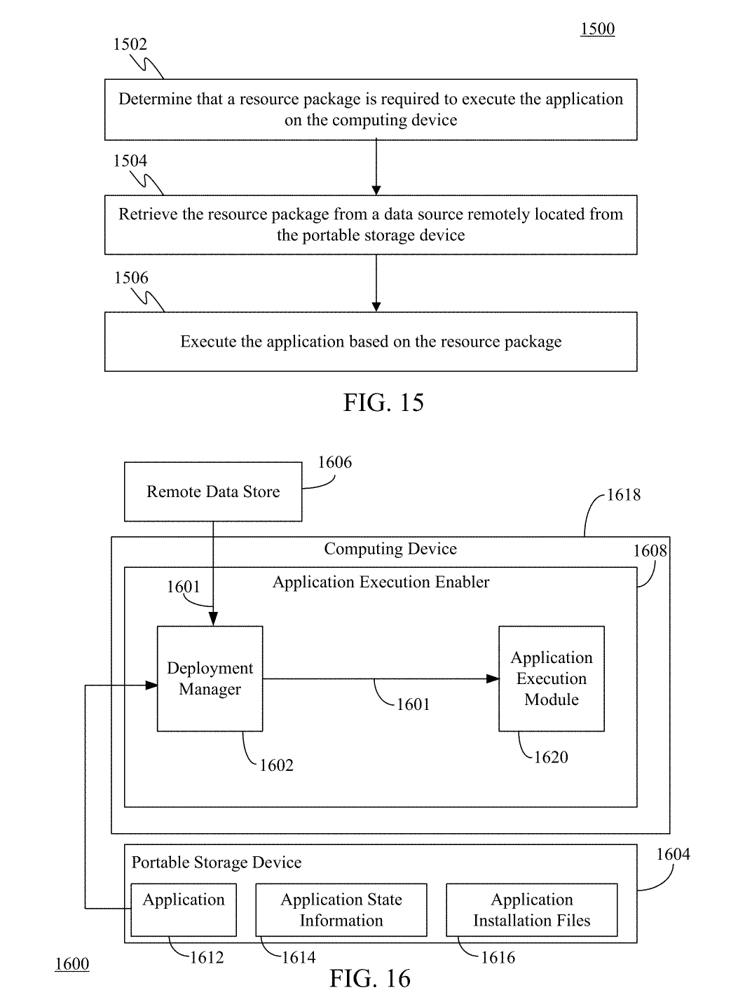

FIG. 15 depicts a flowchart 1500 of a method for enabling an application in accordance with another example. The method of flowchart 1500 may be implemented by a computing device 1618 in FIG. 16. FIG. 16 is a block diagram 1600 of computing device 1618 coupled to a portable storage device 1604 in accordance with an example. Computing device 1618 is an example of computing device 718, and portable storage device 1604 is an example of portable storage device 704, as described above with reference to FIG. 14. As shown in FIG. 16, computing device 1618 includes an application execution enabler 1608. Application execution enabler 1608 is an example of application execution enabler 708, as shown in FIG. 14. As further shown in FIG. 16, application execution enabler 1608 includes a deployment manger 1602 and an application execution module 1620. Application execution module 1620 is an example of application execution module 1220, as shown in FIG. 12. Portable storage device 1604 has stored thereon an application 1612, application state information 1614, and application installation file(s) 1616. Application 1612, application state information 1614, and application installation file(s) 1616 are examples of application 712, application state information 714, and application installation file(s) 716, as described above with reference to FIG. 14. Other structural and operational examples will be apparent to persons skilled in the relevant art(s) based on the following discussion regarding flowchart 1500 and block diagram 1600.

Flowchart 1500 begins with step 1502. In step 1502, a determination is made that a resource package is required to execute the application on the computing device. For example, computing device 1618 may not be fully compatible with application 1612. For instance, computing device 1618 may have a different processing architecture than another computing device (e.g., computing device 302, as shown in FIG. 5) on which application 1612 was executed, and thus, a resource package comprising resources that enable application 1612 to execute on computing device may be required. In another example, computing device 1618 may be coupled to a screen having a different size than a screen coupled to the other computing device and/or may be compatible with different resolutions than the other computing device. Thus, a resource package that includes user interface element assets (e.g., images, dialog box, and/or other user interface element assets) may be required. In yet another example, computing device 1608 may be configured to display text in a language that is different than the language used for the other computing device. Thus, a resource package that provides support for additional language(s) for application 1612 may be required.

With reference to FIG. 16, deployment manager 1602 may determine that a resource package is required to execute application 1612 on computing device 1618. Deployment manager 1602 may make this determination in various ways, including based on parameters of application 1612, system requests made by application 1612, etc.

At step 1606, the resource package is retrieved form a remote data store 1606. For example, with reference to FIG. 16, deployment manger 1602 may retrieve a resource package 1601 from remote data store 1606 and provide resource package 1601 to application execution module 1620. Examples of remote data store 1606 include the Windows Store™ provided by Microsoft Corporation, the App Store™ provided by Apple, Inc., the Google Play Store™ provided by Google, Inc., etc.

At step 1506, the application is executed based on the resource package. For example, with reference to FIG. 16, application execution module 1620 may execute application 1612 based on resource package 1601. For example, resource package 1601 may be installed (e.g., on portable storage device 1604 and/or computing device 1618), thereby expanding the functionality of application 1612, and application 1612 is executed accordingly.

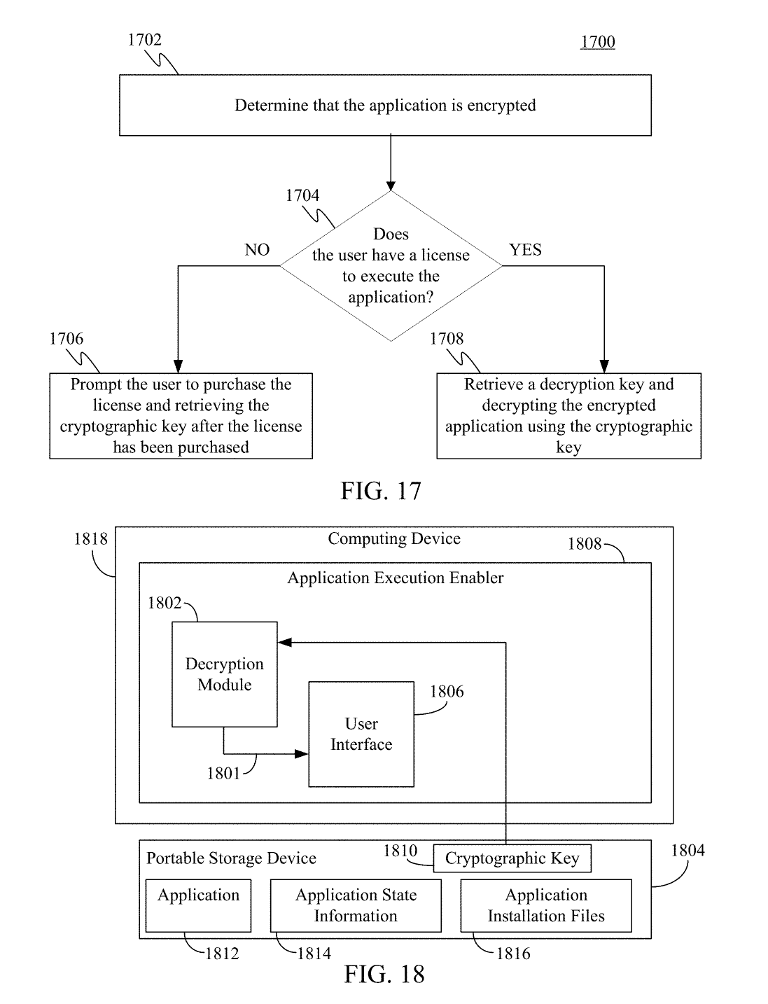

FIG. 17 depicts a flowchart 1700 of a method for enabling an application in accordance with a further example. In an example, flowchart 1700 may be implemented by a computing device 1818 in FIG. 18. FIG. 18 is a block diagram 1800 of computing device 1818 coupled to a portable storage device 1804 in accordance with an example. Computing device 1818 is an example of computing device 1616, and portable storage device 1804 is an example of portable storage device 1606, as respectively described above with reference to FIG. 16. As shown in FIG. 18, computing device 1818 includes an application execution enabler 1808. Application execution enabler 1808 is an example of application execution enabler 1608, as shown in FIG. 16. As further shown in FIG. 18, application execution enabler 1808 includes a decryption module 1802 and a user interface 1806. User interface 1806 is an example of user interface 706, as shown in FIG. 7. Portable storage device 1804 has stored thereon an application 1812, application state information 1814, and application installation file(s) 1816. Application 1812, application state information 1814, and application installation file(s) 1816 are examples of application 1612, application state information 1614, and application installation file(s) 1616, as described above with reference to FIG. 16. Other structural and operational examples will be apparent to persons skilled in the relevant art(s) based on the following discussion regarding flowchart 1700 and block diagram 1800.

Flowchart 1700 begins with step 1702. At step 1702, it is determined that an application is encrypted. For example, with reference to FIG. 18, decryption module 1802 determines that application 1812 is encrypted.

At step 1704, a determination is made as to whether the user has a license to execute the application. For example, with reference to FIG. 18, decryption module 1802 determines whether the user has a license to execute application 1812. For example, decryption module 1802 may search computing device 1818 for a license associated with application 1812 and/or may communicate with a remotely-located data store (e.g., remote data store 1606, as described above with reference to FIG. 16, a software license server, etc.) and determine whether the user has a license associated with application 1812. In response to a determination that the user does not have a license, flow continues to step 1706. Otherwise, flow continues to step 1708.

At step 1706, the user is prompted to purchase the license and a cryptographic key is retrieved after the license has been purchased. For example, with reference to FIG. 18, decryption module 1802 may provide an indication 1801 to user interface 1806 indicating that the user does not have a license. In response, user interface 1806 may display a prompt to the user indicating that the user must purchase a license and/or may further provide an option for the user to purchase the license.

At step 1708, a cryptographic key is retrieved and the encrypted application is decrypted using the cryptographic key. For example, with reference to FIG. 18, decryption module 1802 retrieves the cryptographic key. As shown in FIG. 18, the cryptographic key (e.g., cryptographic key 1810) is stored on portable storage device 1804, and decryption module 1802 retrieves cryptographic key 1810 from portable storage device 1804. Alternatively, cryptographic key may be stored on a remote data source (e.g., remote data store 1606, as shown in FIG. 16), and decryption module 1802 may retrieve cryptographic key from the remote data source.

### III. Example Mobile and Stationary Device

First computing device 102, operating system 108, portable application installer 110, second computing device 118, operating system 122, portable application loader 124, portable storage device 304, installer module 306, encryption module 308, portable application installer 310, state manager 320, application detector 702, user interface 706, application execution enabler 708, application association module 711, application installer 717, portable application loader 724, application execution enabler 1208, state manager 1210, application execution module 1220, deployment manager 1602, application execution enabler 1608, application execution module 1620, decryption module 1802, user interface 1806, application execution enabler 1808, flowchart 200, flowchart 400, flowchart 600, flowchart 1000, flowchart 1300, flowchart 1500, and/or flowchart 1700 may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 19 is a block diagram 1900 of an exemplary mobile device 1902 that may implement examples described herein. For example, mobile device 1902 may be used to implement first computing device 102, second computing device 118, computing device 302, computing device 718, computing device 1218, computing device 1618, and/or computing device 1818. As shown in FIG. 19, mobile device 1902 includes a variety of optional hardware and software components, shown generally as components 1902. Any component in mobile device 1902 can communicate with any other component, although not all connections are shown for ease of illustration. Mobile device 1902 can be any of a variety of mobile devices described or mentioned elsewhere herein or otherwise known (e.g., cell phone, smartphone, handheld computer, Personal Digital Assistant (PDA), etc.) and can allow wireless two-way communications with one or more mobile devices over one or more communications networks 1904, such as a cellular or satellite network, or with a local area or wide area network.

For instance, components 1902 of mobile device 1902 are examples of components that may be included in first computing device 102, second computing device 118, computing device 302, computing device 718, computing device 1218, computing device 1618, and/or computing device 1818, in mobile device examples. Any number and combination of the features/elements of components 1902 may be included in a mobile device example, as well as additional and/or alternative features/elements, as would be known to persons skilled in the relevant art(s). Such features/elements may also be included in stationary device examples.

Mobile device 1902 can include a controller or processor referred to as processor circuit 1910 for performing such tasks as signal coding, image processing, data processing, input/output processing, power control, and/or other functions. Processor circuit 1910 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1910 may execute program code stored in a computer readable medium, such as program code of one or more applications 1914, operating system 1912, any program code stored in memory 120, etc. Operating system 1912 can control the allocation and usage of the components 102 and support for one or more application programs 1514 (a.k.a. applications, “apps”, etc.). Application programs 1914 can include common mobile computing applications (e.g., email applications, calendars, contact managers, web browsers, messaging applications) and any other computing applications (e.g., word processing applications, mapping applications, media player applications).

As illustrated, mobile device 1902 can include memory 1920. Memory 1920 can include non-removable memory 1922 and/or removable memory 1924. The non-removable memory 1922 can include RAM, ROM, flash memory, a hard disk, or other well-known memory storage technologies. The removable memory 1924 can include flash memory or a Subscriber Identity Module (SIM) card, which is well known in GSM communication systems, or other well-known memory storage technologies, such as “smart cards.” The memory 1920 can be used for storing data and/or code for running the operating system 1912 and the applications 1914. Example data can include web pages, text, images, sound files, video data, or other data sets to be sent to and/or received from one or more network servers or other devices via one or more wired or wireless networks. Memory 1920 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 1920. These programs include operating system 1912, one or more application programs 1914, and other program modules and program data. Examples of such application programs or program modules may include, for example, computer program logic (e.g., computer program code or instructions) for implementing, operating system 108, portable application installer 110, operating system 122, portable application loader 124, portable storage device 304, portable application installer 310, installer module 302, encryption module 306, state manager 308, application detector 702, user interface 706, application execution enabler 708, application association module 711, application installer 717, portable application loader 724, application execution enabler 1208, state manager 1210, application execution module 1220, application execution enabler 1608, deployment manager 1062, application execution module 1620, application execution enabler 1808, decryption module 1802, user interface 1806, flowchart 200, flowchart 400, flowchart 600, flowchart 1000, flowchart 1300, flowchart 1500, and/or flowchart 1700 (including any suitable step of flowcharts 200, 400, 600, 1000, 1300, 1500, and 1700), and/or further examples described herein.

Mobile device 1902 can support one or more input devices 1930, such as a touch screen 1932, microphone 1934, camera 1936, physical keyboard 1938 and/or trackball 1940 and one or more output devices 1950, such as a speaker 1952 and a display 1954. Touch screens, such as touch screen 1932, can detect input in different ways. For example, capacitive touch screens detect touch input when an object (e.g., a fingertip) distorts or interrupts an electrical current running across the surface. As another example, touch screens can use optical sensors to detect touch input when beams from the optical sensors are interrupted. Physical contact with the surface of the screen is not necessary for input to be detected by some touch screens. For example, the touch screen 1932 may be configured to support finger hover detection using capacitive sensing, as is well understood in the art. Other detection techniques can be used, as already described above, including camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches or between 0.75 inches and 1 inch, or between 1 inch and 1.5 inches, etc.

The touch screen 1932 is shown to include a control interface 1992 for illustrative purposes. The control interface 1992 is configured to control content associated with a virtual element that is displayed on the touch screen 1932. In an example, the control interface 1992 is configured to control content that is provided by one or more of applications 1914. For instance, when a user of the mobile device 1902 utilizes an application, the control interface 1992 may be presented to the user on touch screen 1932 to enable the user to access controls that control such content. Presentation of the control interface 1992 may be based on (e.g., triggered by) detection of a motion within a designated distance from the touch screen 1932 or absence of such motion. Examples for causing a control interface (e.g., control interface 1992) to be presented on a touch screen (e.g., touch screen 1932) based on a motion or absence thereof are described in greater detail below.

Other possible output devices (not shown) can include piezoelectric or other haptic output devices. Some devices can serve more than one input/output function. For example, touch screen 1932 and display 1954 can be combined in a single input/output device. The input devices 1930 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1912 or applications 1914 can comprise speech-recognition software as part of a voice control interface that allows a user to operate the device 1500 via voice commands. Further, mobile device 1902 can comprise input devices and software that allows for user interaction via a user's spatial gestures, such as detecting and interpreting gestures to provide input to a gaming application.

Wireless modem(s) 1960 can be coupled to antenna(s) (not shown) and can support two-way communications between processor circuit 1910 and external devices, as is well understood in the art. The modem(s) 1960 are shown generically and can include a cellular modem 1966 for communicating with the mobile communication network 1904 and/or other radio-based modems (e.g., Bluetooth 1964 and/or Wi-Fi 1962). Cellular modem 1966 may be configured to enable phone calls (and optionally transmit data) according to any suitable communication standard or technology, such as GSM, 3G, 4G, 5G, etc. At least one of the wireless modem(s) 1960 is typically configured for communication with one or more cellular networks, such as a GSM network for data and voice communications within a single cellular network, between cellular networks, or between the mobile device and a public switched telephone network (PSTN).

Mobile device 1902 can further include at least one input/output port 1980, a power supply 1982, a satellite navigation system receiver 1984, such as a Global Positioning System (GPS) receiver, an accelerometer 1986, and/or a physical connector 1990, which can be a USB port, IEEE 1394 (FireWire) port, and/or RS-232 port. The illustrated components 1902 are not required or all-inclusive, as any components can be not present and other components can be additionally present as would be recognized by one skilled in the art.

FIG. 20 depicts an example processor-based computer system 2000 that may be used to implement various examples described herein. For example, system 2000 may be used to implement first computing device 102, second computing device 118, computing device 302, computing device 718, computing device 1218, computing device 1618, and/or computing device 1818. System 200 may also be used to implement any of the steps of any of flowchart 200, flowchart 400, flowchart 600, flowchart 1000, flowchart 1300, flowchart 1500, and/or flowchart 1700, as described above. The description of system 2000 provided herein is provided for purposes of illustration, and is not intended to be limiting. Examples may be implemented in further types of computer systems, as would be known to persons skilled in the relevant art(s).

As shown in FIG. 20, system 2000 includes a processing unit 2002, a system memory 2004, and a bus 2006 that couples various system components including system memory 2004 to processing unit 2002. Processing unit 2002 may comprise one or more circuits, microprocessors or microprocessor cores. Bus 2006 represents one or more of any of several types of bus structures, including a memory bus or memory controller, a peripheral bus, an accelerated graphics port, and a processor or local bus using any of a variety of bus architectures. System memory 2004 includes read only memory (ROM) 2008 and random access memory (RAM) 2010. A basic input/output system 2012 (BIOS) is stored in ROM 2008.

System 2000 also has one or more of the following drives: a hard disk drive 2014 for reading from and writing to a hard disk, a magnetic disk drive 2016 for reading from or writing to a removable magnetic disk 2018, and an optical disk drive 2020 for reading from or writing to a removable optical disk 2022 such as a CD ROM, DVD ROM, BLU-RAY™ disk or other optical media. Hard disk drive 2014, magnetic disk drive 2016, and optical disk drive 2020 are connected to bus 2006 by a hard disk drive interface 2024, a magnetic disk drive interface 2026, and an optical drive interface 2028, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 2030, one or more application programs 2032, other program modules 2034, and program data 2036. In accordance with various examples, the program modules may include computer program logic that is executable by processing unit 2002 to perform any or all of the functions and features of first computing device 102, second computing device 118, computing device 302, computing device 718, computing device 1118, computing device 1618, and/or computing device 1818. The program modules may also include computer program logic that, when executed by processing unit 1802, causes processing unit 1802 to perform any of the steps of any of flowchart 200, flowchart 400, flowchart 600, flowchart 1000, flowchart 1300, flowchart 1500, and/or flowchart 1700, as described above.

A user may enter commands and information into system 2000 through input devices such as a keyboard 2038 and a pointing device 2040 (e.g., a mouse). Other input devices (not shown) may include a microphone, joystick, game controller, scanner, or the like. In one example, a touch screen is provided in conjunction with a display 2044 to allow a user to provide user input via the application of a touch (as by a finger or stylus for example) to one or more points on the touch screen. These and other input devices are often connected to processing unit 2002 through a serial port interface 2042 that is coupled to bus 2006, but may be connected by other interfaces, such as a parallel port, game port, or a universal serial bus (USB). Such interfaces may be wired or wireless interfaces.

Display 2044 is connected to bus 2006 via an interface, such as a video adapter 1846. In addition to display 2044, system 2000 may include other peripheral output devices (not shown) such as speakers and printers.

System 2000 is connected to a network 2048 (e.g., a local area network or wide area network such as the Internet) through a network interface 2050, a modem 2052, or other suitable means for establishing communications over the network. Modem 2052, which may be internal or external, is connected to bus 2006 via serial port interface 2042.

As used herein, the terms “computer program medium,” “computer-readable medium,” and “computer-readable storage medium” are used to generally refer to memory devices or storage structures such as the hard disk associated with hard disk drive 2014, removable magnetic disk 2018, removable optical disk 2022, as well as other memory devices or storage structures such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Examples are also directed to such communication media.

As noted above, computer programs and modules (including application programs 2032 and other program modules 2034) may be stored on the hard disk, magnetic disk, optical disk, ROM, or RAM. Such computer programs may also be received via network interface 2050, serial port interface 2042, or any other interface type. Such computer programs, when executed or loaded by an application, enable system 2000 to implement features of examples discussed herein. Accordingly, such computer programs represent controllers of the system 2000. Examples are also directed to computer program products comprising software stored on any computer useable medium. Such software, when executed in one or more data processing devices, causes a data processing device(s) to operate as described herein. Examples may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

### IV. Examples

In one example, a method comprises: determining that a portable storage device coupled with a computing device stores an application configured on the portable storage device for execution on the computing device without requiring installation on the computing device; in response to said determining, displaying a user-selectable application identifier for the application to a user of the computing device; detecting that a user has selected the user-selectable application identifier; in response to said detecting, determining whether the application is associated with the user; and in response to determining that the application is associated with the user, enabling the application for execution on the computing device without installation on the computing device.

In an example, the enabling comprises: retrieving state information associated with the selected application from the portable storage device; and executing the selected application based on the retrieved state information without installation on the computing device.

In an example, in response to determining that the application is not associated with the user, enabling the user to install the application on the computing device.

In an example, the determining whether the application is associated with the user comprises: comparing first user identifier utilized to log into the computing device with a second user identifier associated with the application; determining that the application is associated with the user when the first user identifier and the second user identifier match; and determining that the application is not associated with the user when the first user identifier and the second user identifier do not match.

In an example, the enabling comprises: determining that a resource package is required to execute the application on the computing device; retrieving the resource package from a data source remotely located from the portable storage device; and executing the application based on the resource package.

In an example, the resource package comprises at least one of: a language resource package; a graphics resource package; a user interface resource package; or an architecture-specific resource package.

In an example, the enabling comprises: determining that the application is encrypted; determining whether the user has a license to execute the application; in response to determining that the user has the license, retrieving a cryptographic key and decrypting the encrypted application using the cryptographic key; and in response to determining that the user does not have the license, prompting the user to purchase the license and retrieving the cryptographic key after the license has been purchased.

In another example, a system in a computing device comprises: an application detector configured to determine that a portable storage device coupled with a computing device stores an application configured on the portable storage for execution on the computing device without requiring installation on the computing device; a user interface configured to, in response to a determination that the portable storage device stores the application, display a user-selectable application identifier for the application to a user of the computing device, the user interface further configured to detect that a user has selected the user-selectable application identifier; an application association module configured to determine whether the application is associated with the user; and an application execution enabler configured to, in response to a determination that the application is associated with the user, enable the application for execution on the computing device without installation on the computing device.

In an example, the application execution enabler comprises: a state manager configured to retrieve state information associated with the selected application from the portable storage device in response to a determination that the application is associated with the user; an application execution module configured to execute the selected application based on the retrieved state information without installation on the computing device in response to the determination that the application is associated with the user.

In an example, the application association module is configured to determine whether the application is associated with the user by: comparing a first user identifier utilized to log into the computing device is the same as a second user identifier associated with the application; determining that the application is associated with the user when the first user identifier and the second user identifier match; and determining that the application is not associated with the user when the first user identifier and the second user identifier do not match.

In an example, the application execution enabler comprises: a deployment manger configured to: determine that a resource package is required to execute the application on the computing device; and retrieve the resource package from a data source remotely located from the portable storage device; wherein the application execution module is configured to execute the application based on the resource package.

In an example, the resource package comprises at least one of: a language resource package; a graphics resource package; a user interface resource package; or an architecture-specific resource package.

In an example, the application execution enabler comprises: an decryption module configured to: determine that the application is encrypted; determine whether the user has a license to execute the application; in response to a determination that the user has the license, retrieve a cryptographic key and decrypt the encrypted application using the cryptographic key; and in response to a determination that the user does not have the license, prompt the user to purchase the license and retrieve the cryptographic key after the license has been purchased.

In another example, a method comprises; installing an application on a portable storage device; storing state information of the application obtained during execution of the application to the portable storage device; and encrypting the application and the state information using at least one first cryptographic key.

In an example, the method further comprises: storing installation files utilized to install the application on a computing device on the portable storage device; and encrypting the installation files using a second cryptographic key.

In an example, the at least one first cryptographic key is a user-specific cryptographic key.

In an example, the second cryptographic key is a license-specific cryptographic key.

In another example, a system in a computing device comprises: an application installer configured to install an application on a portable storage device; a state manager configured to store state information of the application obtained during execution of the application to the portable storage device; and an encryption module configured to encrypt the application and the state information using at least one first cryptographic key.

In an example, the application installer is further configured to store installation files utilized to install the application on a computing device on the portable storage device, and wherein the encryption module is configured to encrypt the installation files using a second cryptographic key.

In an example, the at least one first cryptographic key is a user-specific cryptographic key.

In an example, the second cryptographic key is a license-specific cryptographic key.

### V. Conclusion

While various examples of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary examples, but should be defined only in accordance with the following claims and their equivalents.

What is claimed is:

1. A method, comprising:
determining that a portable storage device coupled with a computing device stores an application configured on the portable storage device for execution on the computing device without requiring installation on the computing device;
in response to said determining, displaying a user-selectable application identifier for the application to a user of the computing device;
detecting that a user has selected the user-selectable application identifier;
in response to said detecting, determining whether the application is associated with the user; and
in response to determining that the application is associated with the user, enabling the application for execution on the computing device without installation on the computing device.

2. The method of claim 1, said enabling comprising:
retrieving state information associated with the selected application from the portable storage device; and
executing the selected application based on the retrieved state information without installation on the computing device.

3. The method of claim 1, further comprising:
in response to determining that the application is not associated with the user, enabling the user to install the application on the computing device.

4. The method of claim 1, wherein determining whether the application is associated with the user comprises:
comparing first user identifier utilized to log into the computing device with a second user identifier associated with the application;
determining that the application is associated with the user when the first user identifier and the second user identifier match; and
determining that the application is not associated with the user when the first user identifier and the second user identifier do not match.

5. The method of claim 1, wherein said enabling comprises:
determining that a resource package is required to execute the application on the computing device;
retrieving the resource package from a data source remotely located from the portable storage device; and
executing the application based on the resource package.

6. The method of claim 4, wherein the resource package comprises at least one of:
a language resource package;
a graphics resource package;
a user interface resource package; or
an architecture-specific resource package.

7. The method of claim 1, wherein said enabling comprises:
determining that the application is encrypted;
determining whether the user has a license to execute the application;
in response to determining that the user has the license, retrieving a cryptographic key and decrypting the encrypted application using the cryptographic key; and
in response to determining that the user does not have the license, prompting the user to purchase the license and retrieving the cryptographic key after the license has been purchased.

8. A system in a computing device, comprising:
an application detector configured to determine that a portable storage device coupled with a computing device stores an application configured on the portable storage for execution on the computing device without requiring installation on the computing device;
a user interface configured to, in response to a determination that the portable storage device stores the application, display a user-selectable application identifier for the application to a user of the computing device, the user interface further configured to detect that a user has selected the user-selectable application identifier;
an application association module configured to determine whether the application is associated with the user; and
an application execution enabler configured to, in response to a determination that the application is associated with the user, enable the application for execution on the computing device without installation on the computing device.

9. The system of claim 8, wherein the application execution enabler comprises:
a state manager configured to retrieve state information associated with the selected application from the portable storage device in response to a determination that the application is associated with the user; and
an application execution module configured to execute the selected application based on the retrieved state information without installation on the computing device in response to the determination that the application is associated with the user.

10. The system of claim 8, wherein the application association module is configured to determine whether the application is associated with the user by:
comparing a first user identifier utilized to log into the computing device is the same as a second user identifier associated with the application;
determining that the application is associated with the user when the first user identifier and the second user identifier match; and
determining that the application is not associated with the user when the first user identifier and the second user identifier do not match.

11. The system of claim 9, wherein the application execution enabler comprises:
a deployment manger configured to:
determine that a resource package is required to execute the application on the computing device; and
retrieve the resource package from a data source remotely located from the portable storage device; wherein the application execution module is configured to execute the application based on the resource package.

12. The system of claim 11, wherein the resource package comprises at least one of:
a language resource package;
a graphics resource package;
a user interface resource package; or
an architecture-specific resource package.

13. The system of claim 8, wherein the application execution enabler comprises:
an decryption module configured to:
determine that the application is encrypted;
determine whether the user has a license to execute the application;
in response to a determination that the user has the license, retrieve a cryptographic key and decrypt the encrypted application using the cryptographic key; and
in response to a determination that the user does not have the license, prompt the user to purchase the license and retrieve the cryptographic key after the license has been purchased.

14. A method, comprising:
installing an application on a portable storage device;
storing state information of the application obtained during execution of the application to the portable storage device; and
encrypting the application and the state information using at least one first cryptographic key.

15. The method of claim 14, further comprising:
storing installation files utilized to install the application on a computing device on the portable storage device; and
encrypting the installation files using a second cryptographic key.

16. The method of claim 14, wherein the at least one first cryptographic key is a user-specific cryptographic key.

17. The method of claim 14, wherein the second cryptographic key is a license-specific cryptographic key.

18. A system in a computing device, comprising:
an application installer configured to install an application on a portable storage device;
a state manager configured to store state information of the application obtained during execution of the application to the portable storage device; and
an encryption module configured to encrypt the application and the state information using at least one first cryptographic key.

19. The system of claim 18, wherein the application installer is further configured to store installation files utilized to install the application on a computing device on the portable storage device, and
wherein the encryption module is configured to encrypt the installation files using a second cryptographic key.

20. The system of claim 18, wherein the at least one first cryptographic key is a user-specific cryptographic key.
